(19) United States
(12) Patent Application Publication
(10) Pub. No.: US 2013/0007477 A1
(43) Pub. Date: Jan. 3, 2013

(54) SERVER

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/188,503

(22) Filed: Jul. 22, 2011

(30) Foreign Application Priority Data
Jun. 29, 2011 (CN) 201110179267.8

(51) Int. Cl. G06F 1/26

(52) U.S. Cl. 713/300

(57) ABSTRACT

A server includes an enclosure, a motherboard, a number of hard disk drives (HDDs), a number of built-in batteries, and a server power module. The motherboard includes a power management interface and a base management controller. When the server power module works normally, the server power module outputs a voltage to the motherboard to power the motherboard, and charge the built-in batteries. When the server power module cannot work normally, the built-in batteries output voltages to the motherboard to keep the motherboard working, while the base management controller stores data of the server to the HDDs and powers off the motherboard.

### BACKGROUND

1. Technical Field

The present disclosure relates to a server.

2. Description of Related Art

Generally, power supply systems of servers include conventional power supplies or uninterruptible power systems. When a conventional power supply is used as the sole power supply for a server, a variety of problems, such as data loss, can occur if the power supply fails.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an isometric view of an embodiment of a server, the server including a plurality of built-in batteries.

FIG. 2 is a schematic view of one of the built-in batteries of FIG. 1.

FIG. 3 is block diagram of the server of FIG. 1.

FIG. 4 a block diagram of an interface of the built-in battery connected to an anode and a cathode of the built-in battery of FIG. 2.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

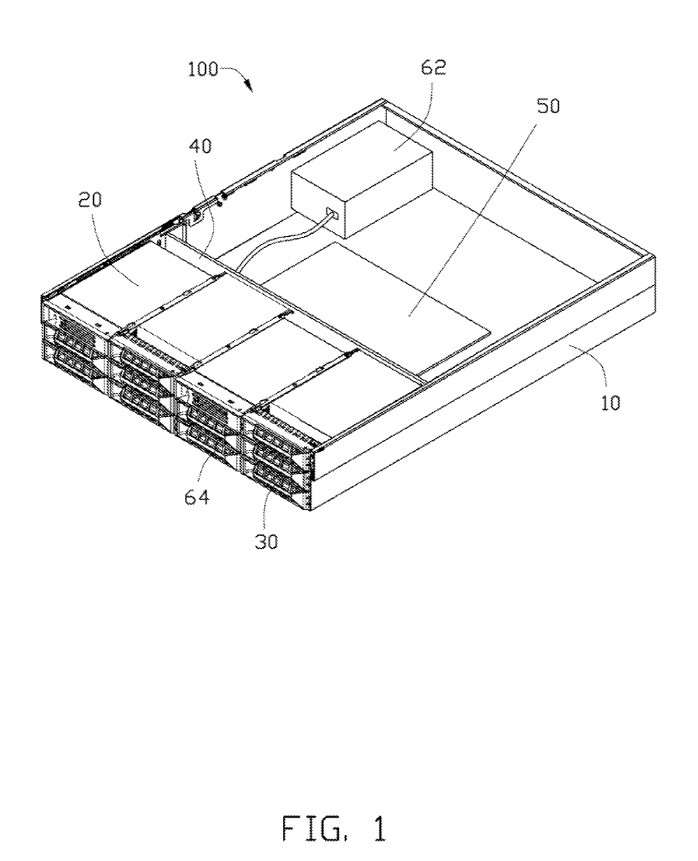

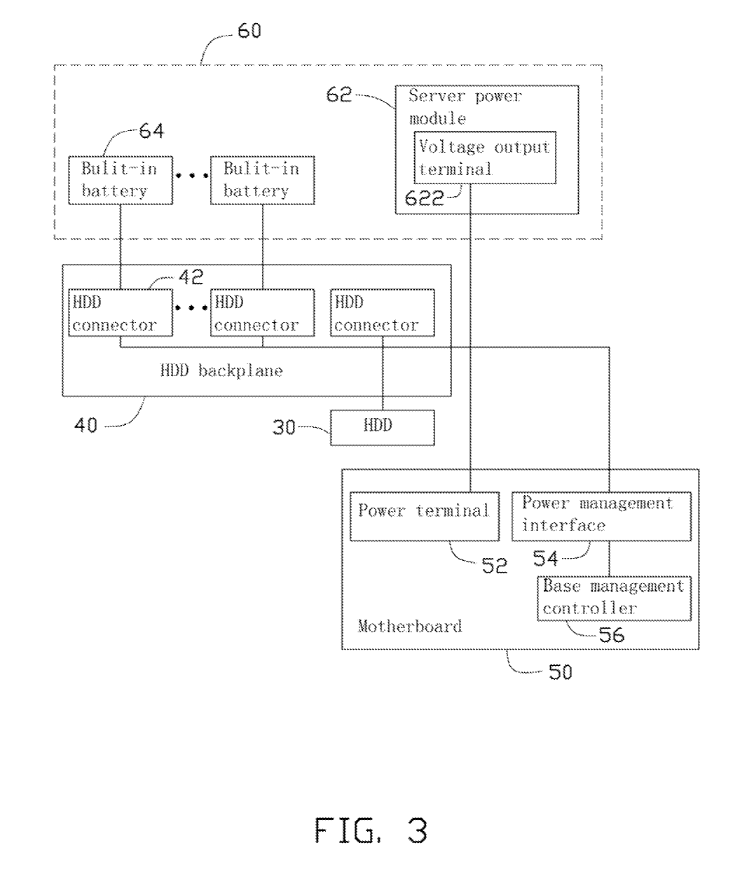

Referring to FIGS. 1 and 3, an embodiment of a server 100 includes an enclosure 10, a plurality of HDDs 30, an HDD backplane 40, a motherboard 50, and a power supply system 60. The enclosure 10 defines a plurality of parallel hard disk drive (HDD) receiving spaces 20 in an end of the enclosure 10. The power supply system 60 includes a server power module 62 and a plurality of built-in batteries 64. The HDD receiving spaces 20 are used to receive the HDDs 30 and the built-in batteries 64. The HDD backplane 40 and the motherboard 50 are mounted in the enclosure 10, behind the HDDs 30. The HDD backplane 40 includes a plurality of HDD connectors 42 connected to the HDDs 30 and the built-in batteries 64.

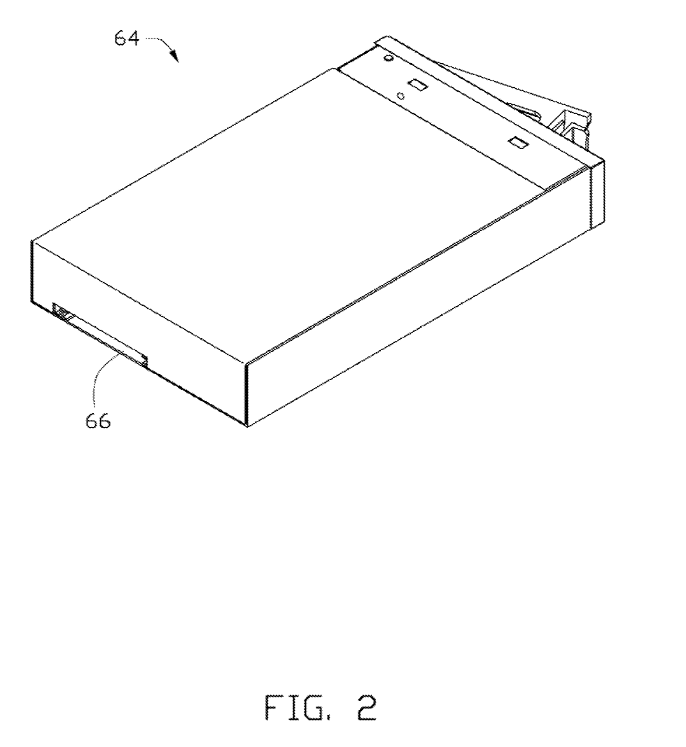

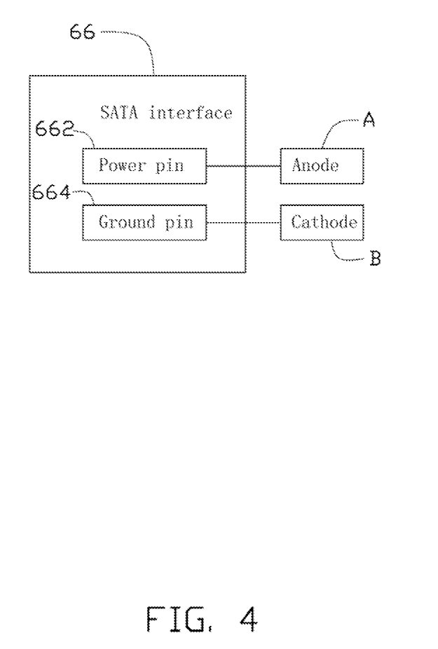

Referring to FIGS. 2 and 4, each built-in battery 64 is substantially rectangle shaped. Each HDD is substantially rectangle shaped. An outline of each built-in battery 64 is substantially the same as an outline of the HDD 30, thereby the built-in batteries 64 can be received in the HDD receiving spaces 20. A serial advanced technology attachment (SATA) interface 66 is mounted to the rear end of each built-in battery 64. The SATA interface 66 includes a power pin 662 and a ground pin 664. The power pin 662 is connected to an anode A of the built-in battery 64. The ground pin 664 is connected to a cathode B of the built-in battery 64.

Referring to FIG. 3, the motherboard 50 includes a power terminal 52, a power management interface 54, and a base management controller 56. A voltage output terminal 622 of the server power module 62 is connected to the power terminal 52 to power the motherboard 50. The base management controller 56 is connected to the voltage output terminal 622 through the power management interface 54, to determine whether the server power module 62 outputs a voltage. If the server power module 62 outputs the voltage, it denotes that the server power module 62 can work normally. If the server power module 62 fails to output the voltage, it denotes that the server power module 62 cannot work normally. The voltage output terminal 622 is also connected to each HDD connector 42 of the HDD backplane 40.

When the HDDs 30 and the built-in batteries 64 are received in the HDD receiving spaces 20, the interface (not shown) of each HDD 30 and the SATA interface 66 of each built-in battery 64 are respectively connected to the corresponding HDD connector 42 of the HDD backplane 40. A power pin of the interface of each HDD 30 and the power pin 662 of the SATA interface 66 of each built-in battery 64 are connected to the voltage output terminal 622 through corresponding pins of the corresponding HDD connectors 42. A ground pin of the interface of each HDD 30 and the ground pin 664 of the SATA interface 66 of each built-in battery 64 are grounded through corresponding pins of the corresponding HDD connectors 42.

When the server power module 62 works normally, the voltage output terminal of the server power module 62 outputs the voltage to each built-in battery 64 to charge the built-in battery 64, and outputs the voltage to the power terminal 52 of the motherboard 50 to power the motherboard 50. At that time, the base management controller 56 also receives the voltage from the server power module 62 and determines that the server power module 62 can work normally.

When the server power module 62 cannot work normally, the voltage output terminal 622 fails to output the voltage to each built-in battery 64, the power terminal 52, and base management controller 56. The built-in batteries 64, however, output a voltage to the power terminal 52 of the motherboard 50 to keep the motherboard 50 working. At which time, the base management controller 56 fails to receive the voltage from the server power module 62 and determines that the server power module 62 cannot work normally. The base management controller 56 then responds by saving data from memories of the server 100 to the HDDs 30, and powers off the motherboard 50.

In other embodiments, the built-in batteries 64 can be other shapes and received in other positions of the enclosure 10. The built-in batteries 64 can directly be connected to the voltage output terminal 622 of the server power module 62.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A server comprising:
an enclosure;
a plurality of hard disk drives (HDDs) received in the enclosure;
a power supply system received in the enclosure and comprising:
a server power module comprising a voltage output terminal; and
a plurality of built-in batteries connected to the voltage output terminal of the server power module; and
a motherboard mounted in the enclosure, comprising a power terminal connected to the voltage output terminal of the server power module, a power management interface, and a base management controller connected to the voltage output terminal of the server power module through the power management to determine whether the server power module works;
wherein if the base management controller receives a voltage from the server power module, the base management controller determines that the server power module works normally, the server power module outputs the voltage to the power terminal of the motherboard to power the motherboard and charge the built-in batteries; wherein if the base management controller fails to receive the voltage from the server power module, the base management controller determines that the server power module is abnormal, the server power module fails to output the voltage, the built-in batteries output voltages to keep the motherboard working, the base management controller stores data of the server to the HDDs and powers off the motherboard.

2. The server of claim 1, further comprising an HDD backplane, wherein the enclosure defines a plurality of HDD receiving spaces in an end of the enclosure to receive the plurality of HDDs and built-in batteries, wherein the plurality of HDDs and the plurality of built-in batteries are received in the plurality of HDD receiving spaces, the HDD backplane comprises a plurality of HDD connectors, each built-in battery comprises an interface to be connected to a corresponding HDD connector, the interface of each built-in battery comprises a power pin connected to an anode of the built-in battery and a ground pin connected to a cathode of the built-in battery, when the built-in batteries are received in the HDD receiving spaces, the power pins of the built-in batteries are connected to the voltage output terminal of the server power module through the corresponding HDD connectors, the ground pins of the built-in batteries are grounded through the corresponding HDD connectors.

3. The server of claim 2, wherein the interfaces of the built-in battery are serial advanced technology attachment interfaces.

4. The server of claim 2, wherein each built-in battery is substantially rectangle shaped, each HDD is substantially rectangle shaped, an outline of each built-in battery is same as an outline of each HDD.
